(19) United States
(12) Patent Application Publication
(10) Pub. No.: US 2015/0046185 A1
(43) Pub. Date: Feb. 12, 2015

(54) SYSTEM AND METHOD FOR ENHANCED INTERACTIVE REPORTING OF MEDICAL TEST RESULTS

(71) Applicant: QUEST DIAGNOSTICS INC., Wilmington, DE (US)

(72) Inventor: Tim MCGUIRE, Wilmington, DE (US)

(73) Assignee: QUEST DIAGNOSTICS INC., Wilmington, DE (US)

(21) Appl. No.: 14/215,695

(22) Filed: Mar. 17, 2014

Related U.S. Application Data
(60) Provisional application No. 61/791,789, filed on Mar. 15, 2013.

(51) Int. Cl. G06F 19/00; H04L 12/58

(52) U.S. Cl. CPC G06F 19/322; H04L 51/04; G06F 19/3418
USPC 705/3

(57) ABSTRACT

An application for providing interactive reports of medical test results that may be integrated with other medical information and services on a mobile device.

### CROSS REFERENCE TO RELATED APPLICATIONS

This application is related to pending U.S. provisional patent application No. 61/791,789, filed Mar. 15, 2013, and titled “System and Method for Enhanced Interactive Reporting of Medical Test Results,” the entirety of which is incorporated herein by reference.

### COPYRIGHT NOTICE

A portion of the disclosure of this patent document contains material that is subject to copyright protection. The copyright owner has no objection to the facsimile reproduction by anyone of the patent document or the patent disclosures, as it appears in the Patent and Trademark Office patent files or records, but otherwise reserves all copyright rights whatsoever.

### BACKGROUND

Health care increasingly depends on diagnostic medical testing. At the same time, health care providers increasingly rely on computerized systems to manage information related to health care.

The two have been integrated in some ways. For example, lab orders and results can be accepted and delivered through computer networks, such as the Internet. Laboratory information systems may monitor and control some or all parts of testing, including, for example, specimen collection and tracking, recording results, quality assurance, and billing.

But medical testing still fails to take advantage of many kinds of technological innovation, particularly in providing test results. Although test results may be stored, retrieved, and delivered using networked computer systems, the form of the results fails to take advantage of the wealth of information and interconnection that modern computer networks can provide.

### SUMMARY OF THE INVENTION

Embodiments of the invention relate to providing interactive reports of medical test results that may be integrated with other medical information and services. Delivered electronically, a report according to an embodiment of the invention may take advantage of capabilities of mobile computing device such as a smartphone or a tablet. A report according to an embodiment of the invention may therefore be customizable according to the preferences of the physician who receives it.

A report according to an embodiment of the invention includes one or more results of medical tests performed on a patient. In addition to the results, however, a report may make available the patient's historical test results for information and/or services related to one or more of the tests and/or results.

For example, according to an embodiment of the invention, a method of delivering a laboratory report comprises electronically delivering a report that may include information identifying one or more pathologists, technicians, or other persons involved in performing the test and one or more interactive tools for communicating with them. Such tools may include, for example, text, voice, or video messaging and/or real-time chat.

In an embodiment of the invention, an interactive laboratory report comprises results of one or more laboratory tests and one or more user interface elements for acquiring further information about one or more of: a reported test, a test result, a medical condition that may be associated with a test and/or result, and/or a drug or other medical treatment that may be associated with a test and/or results.

Once a report according to an embodiment of the invention has been acquired, versions of some information and/or services may be provided in the absence of network services, e.g., by caching information and/or queuing requests. For example, historical medical information related to the report and/or other information may be downloaded when a network connection is active and cached on the user's device. Similarly, in an embodiment of the invention, when a network connection is not available, requests such as lab orders or electronic prescriptions may be, e.g., stored for transmission later, when connectivity has been restored.

### DESCRIPTION OF THE DRAWINGS

FIG. 1 depicts functional components of a representative computer system.

FIG. 2 depicts functional components of a representative mobile device.

FIG. 3 depicts elements of interconnected wired and wireless networks.

FIGS. 4A-18 depict screens according to embodiments of the invention.

### DETAILED DESCRIPTION OF PREFERRED EMBODIMENTS

Embodiments of the invention relate to enhanced interactive reports of medical tests. “Report” is used in a broad sense herein to refer to an embodiment of the results of one or more medical tests, such as the diagnostic physical and/or chemical analysis of cells, tissues, body fluids, and/or anatomic structures of a patient. A report may also include, e.g., patient information, laboratory information, and/or medical information associated with one or more tests and/or their results.

Consistent with its ordinary meaning, however, “report” does not designate all collections of medical information that include results of a medical test. As used herein, a report refers to results of exactly one, specifically identified, test, panel of tests, or requisition, where the result or results are regarded at least contextually as a unit that exists mainly to deliver those results. Although a report may include additional information, the report is organized so that the main focus is presentation of the result or results, and the additional information primarily relates to the test or tests and/or the results.

A report in connection with an embodiment of the invention may be presented by a mobile computing device (or “mobile device” for short). A mobile device is a device, such as a smartphone or tablet, that may be, e.g., easily portable, powered from an internal source, intended for use while the user supports the device in one or both hands, and capable of sending and receiving information, e.g., wirelessly via one or more voice and/or data networks.

For brevity, an application (such as, e.g., a software application) for use on a mobile device may be referred to herein as a “mobile application” or “app”.

It will be appreciated that an app, operating on the mobile device to process information, may use one or more facilities provided by the hardware and/or software of the device to cause information to be transmitted from the mobile device. Similarly, information may be received by the device and, e.g., made available to an application by one or more facilities provided by the hardware and/or software of the mobile device. For brevity, such operations may be referred to simply as transmission and reception of information, respectively, by the app.

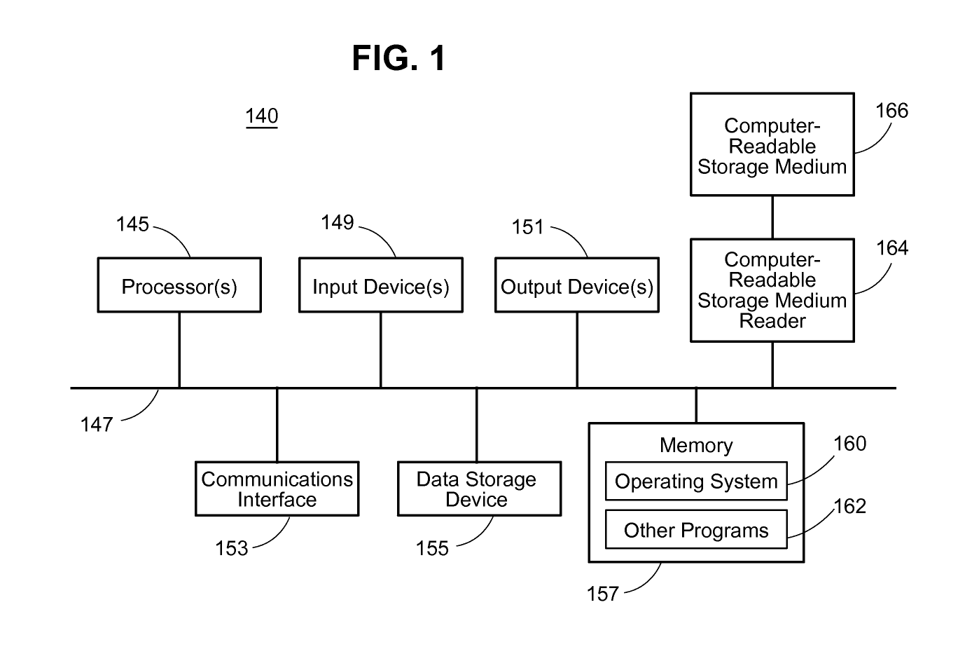

Embodiments of the invention may be practiced in connection with one or more programmable digital computers. FIG. 1 is a block diagram of a representative computer system 140 such as may be used in connection with an embodiment of the invention.

The computer system 140 includes at least one processor 145, such as, e.g., an Intel Core™ 2 microprocessor or a Freescale™ PowerPC™ microprocessor, coupled to a communications channel 147. The computer system 140 further includes at least one input device 149 such as, e.g., a keyboard, mouse, touch pad or screen, or other selection, pointing, and/or input device, at least one output device 151 such as, e.g., a CRT or LCD display, a communications interface 153, a data storage device 155, which may comprise, e.g., a magnetic disk, an optical disk, and/or another computer-readable storage medium, and memory 157 such as Random-Access Memory (RAM), each coupled to the communications channel or bus 147. The communications interface 153 may be coupled to a network such as the Internet.

A person skilled in the art will recognize that a computer system may have multiple channels 147, which may be interconnected. In a configuration comprising multiple interconnected channels, components may be considered to be coupled to one another despite being directly connected to different communications channels. Additionally, any connection between or among any one or more components may include one or more interfaces.

One skilled in the art will recognize that, although the data storage device 155 and memory 157 are depicted as different units, the data storage device 155 and memory 157 can be parts of the same unit or units, and that the functions of one can be shared in whole or in part by the other, e.g., as RAM disks, virtual memory, etc. It will also be appreciated that any particular computer may have multiple components of a given type, e.g., processors 145, input devices 149, communications interfaces 153, etc.

The data storage device 155 and/or memory 157 may store instructions executable by one or more processors 145 or kinds of processors, data, or both, which may represent, e.g., one or more operating systems, programs, and/or other functions and/or data.

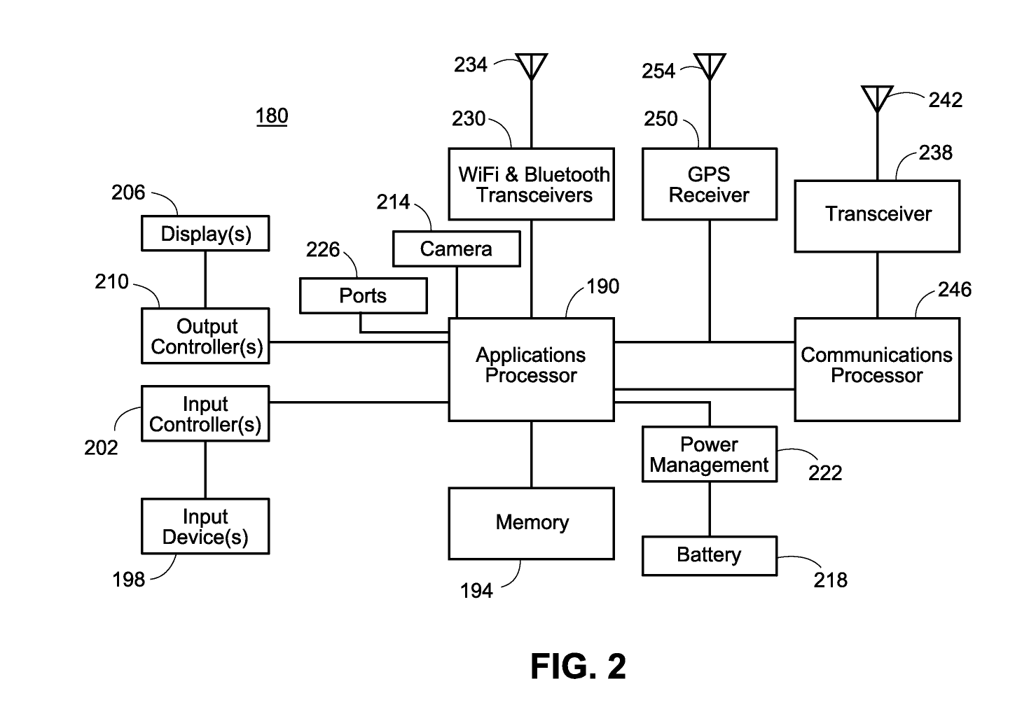

FIG. 2 is a simplified block diagram that illustrates functional components that may be found in a mobile device 180, in connection with an embodiment of the invention. Functions in a mobile device may be controlled, e.g., by a programmable applications processor or microcontroller 190. Memory 194 coupled to the applications processor 190 may include one or more kinds of persistent and/or volatile memory and may store, e.g., instructions to be executed by the applications processor 190 and/or data upon which the applications processor 190 may operate, which may represent, e.g., one or more operating systems, programs, and/or other functions and/or data, among other things.

One or more input devices 198 may be coupled to the applications processor 190, e.g., directly and/or via one or more input controllers 202. Examples of input devices 198 may include, among other possibilities, one or more buttons and/or switches (which may include buttons or switches configured as one or more keypads and/or keyboards), touchscreens, proximity sensors, accelerometers, and/or photosensors.

One or more output devices, including, e.g., one or more displays 206, may be coupled to the applications processor 190, e.g., directly and/or via one or more output controllers 210. A mobile device 180 may output information in ways that do not involve a display 206, e.g., by controlling illumination of one or more LEDs or other devices.

In a mobile device 180, which may be, e.g., a device capable of acting as a telephone, the input devices 198 and output devices 206 may include devices configured to detect and/or emit sound (not pictured).

A mobile device 180 may comprise a camera 214 capable of recording, e.g., still and/or moving pictures. As depicted, the camera 214 may be coupled to the applications processor 190.

The mobile device 180 may be powered, e.g., by one or more batteries 218. The applications processor 190 and/or other components may be powered, e.g., via a power management unit 222 coupled to the battery 218. If the battery 218 is rechargeable, the power management unit 222 may monitor and/or control charging and/or discharging of the battery 218. Power to charge the battery 218 may be supplied, e.g., via one or more external ports 226.

A mobile device 180 may include one or more external ports 226 that may support analog and/or digital input and/or output.

A mobile device 180 may be configured to participate in one or more local area networks (LANs). For example, as FIG. 2 depicts, a mobile device 180 may include one or more transceivers 230 supporting, e.g., Bluetooth® and/or Wi-Fi™ networking. Such a transceiver 230 may be connected, e.g., to one or more antennas 234 and, as FIG. 2 depicts, may be coupled to the applications processor 190.

A mobile device 180 may be configured to interact with one or more wide-area networks (WANs), such as, e.g., cellular voice and/or data networks. For example, as FIG. 2 depicts, a mobile device may comprise one or more cellular transceivers 238 and associated antennas 242. A transceiver 238, as in the depicted device 180, may be coupled to a device such as a communications processor 246, which may include functions such as, for example, of a digital signal processor and/or a microcontroller. A communications processor 246 in a mobile device 180 may also be coupled directly or indirectly to the applications processor 190.

A mobile device 180 may include a unit 250 that is capable of receiving and/or interpreting signals from the Global Positioning System (GPS). The GPS receiver 250 may be coupled to its own antenna 254. The GPS receiver may also be coupled in a mobile device 180 to the applications processor 190, the communications processor 246, or both.

It will be appreciated that FIG. 2 and the discussion of it herein are not meant to describe precisely any particular device, but rather to illustrate functions that may commonly be found in certain classes of devices. A mobile device suitable for use in connection with an embodiment of the invention may differ in its physical or logical organization from the depicted device, and such a device may comprise one or more other components in addition to, or instead of, any one or more discussed or depicted components.

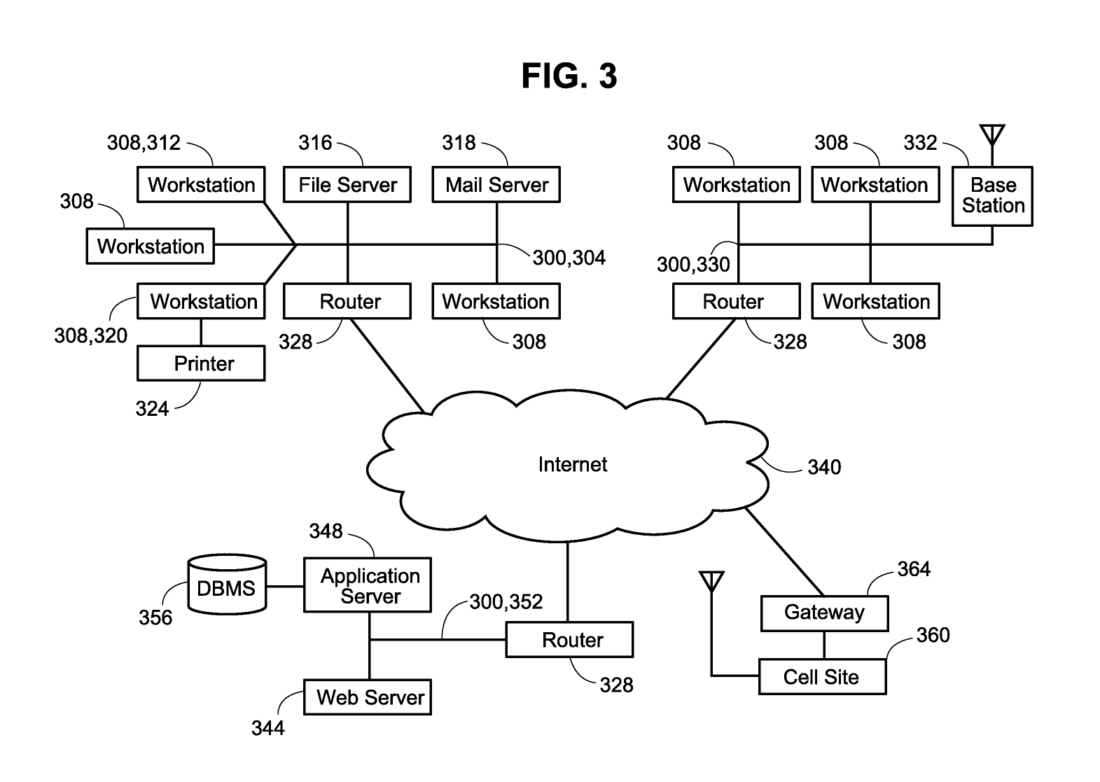

FIG. 3 depicts elements of wired and wireless networks 300 such as, e.g., one or more computers, mobile devices, or both, may use to communicate in connection with an embodiment of the invention. A network 304 may, for example, connect one or more workstations 308 with each other and with other computer systems, such as file servers 316 or mail servers 318. The connection may be achieved tangibly, e.g., via optical cables, or wirelessly.

A network 300 may enable a computer system to provide services to other computer systems, consume services provided by other computer systems, or both. For example, a file server 316 may provide common storage of files for one or more of the workstations 308 on a network 304. A workstation 312 may send data including a request for a file to the file server 316 via the network 304 and the file server 316 may respond by sending the data from the file back to the requesting workstation 312.

The terms “workstation,” “client,” and “server” may be used herein to describe a computer's function in a particular context, but any particular workstation may be indistinguishable in its hardware, configuration, operating system, and/or other software from a client, server, or both. Further, a computer system may simultaneously act as a workstation, a server, and/or a client. For example, as depicted in FIG. 3, a workstation 320 is connected to a printer 324. That workstation 320 may allow users of other workstations on the network 304 to use the printer 324, thereby acting as a print server. At the same time, however, a user may be working at the workstation 320 on a document that is stored on the file server 316.

The terms “client” and “server” may describe programs and running processes instead of or in addition to computer systems such as described above. Generally, a (software) client may consume information and/or computational services provided by a (software) server.

The term “printing system” may be used in a broad sense herein to refer to, e.g., a printer, or a print server and one or more associated printers, configured such that a computer system may send documents and/or commands to the printing system, which may in response print one or more documents or cause one or more documents to be printed by one or more of the printers that the printing system comprises. For example, referring to FIG. 3, “printing system” may refer to the printer 324 or to the combination of the workstation 320 (insofar as it operates as a print server) and the printer 324.

A network 304 may be connected to one or more other networks 300, e.g., via a router 328. A router 328 may also act as a firewall, monitoring and/or restricting the flow of data to and/or from a network 300 as configured to protect the network. A firewall may alternatively be a separate device (not pictured) from the router 328.

Connections within and between one or more networks may be wired or wireless. For example, a computer or mobile device may participate in a LAN using one or more of the standards denoted by the term Wi-Fi™ or other technology. Wireless connections to a network 330 may be achieved through use of, e.g., a device 332 that may be referred to as a “base station”, “gateway”, or “bridge”, among other terms.

A network of networks 300 may be referred to as an internet. The term “the Internet” 340 refers to the worldwide network of interconnected, packet-switched data networks that uses the Internet Protocol (IP) to route and transfer data. A client and server on different networks may communicate via the Internet 340. For example, a workstation 312 may request a World Wide Web document from a Web Server 344. The Web Server 344 may process the request and pass it to, e.g., an Application Server 348. The Application Server 348 may then conduct further processing, which may include, for example, sending data to and/or receiving data from one or more other data sources. Such a data source may include, e.g., other servers on the same network 352 or a different one and/or a Database Management System (“DBMS”) 356.

Depending on the configuration, a computer system such as the application server 348 in FIG. 3 or one or more of its processors may be considered to be coupled, e.g. to the DBMS 356. In addition to or instead of one or more external databases and/or DBMSs, a computer system may incorporate one or more databases, which may also be considered to be coupled to one or more of the processors within the computer system.

Devices, including, e.g., suitably configured mobile devices and computers, may communicate with Internet-connected hosts. In such a connection, the device may communicate wirelessly, e.g., with a cell site 360 or other base station. The base station may then route data communication to and from the Internet 340, e.g., directly or indirectly through one or more gateways 364 and/or proxies (not pictured).

A mobile device may be capable of storing and/or executing one or more application programs (or “applications”). In an embodiment of the invention, an application may provide, e.g., information about one or more patients to a user, who may be a health-care professional such as a physician. Such an application may further assist the user in providing health care, e.g., by allowing the user to add or modify information, send messages, and/or order laboratory tests, among other functions.

A report according to an embodiment of the invention may be distributed as an HTML 5 application. As such, from the user's point of view, the report may appear to be a Web page, which may be viewed in a browser or other application that includes Web access from the user's device. Consistent with HTML 5, the main file that represents the report may refer to one more other documents, including, e.g., media, JavaScript libraries, and CSS. The application may be built using one or more application frameworks, e.g., such as are known in the art, such as Sencha Touch® 2.

The application may indicate that the device is to cache the application and/or to use local storage, thereby making the report available even when the device is offline. In that case, functions that require a net connection, such as messaging, may be unavailable, until the device has a network connection again. Once the connection is established, however, the application or the host application may check for updates to the data and/or make such network functionality available again.

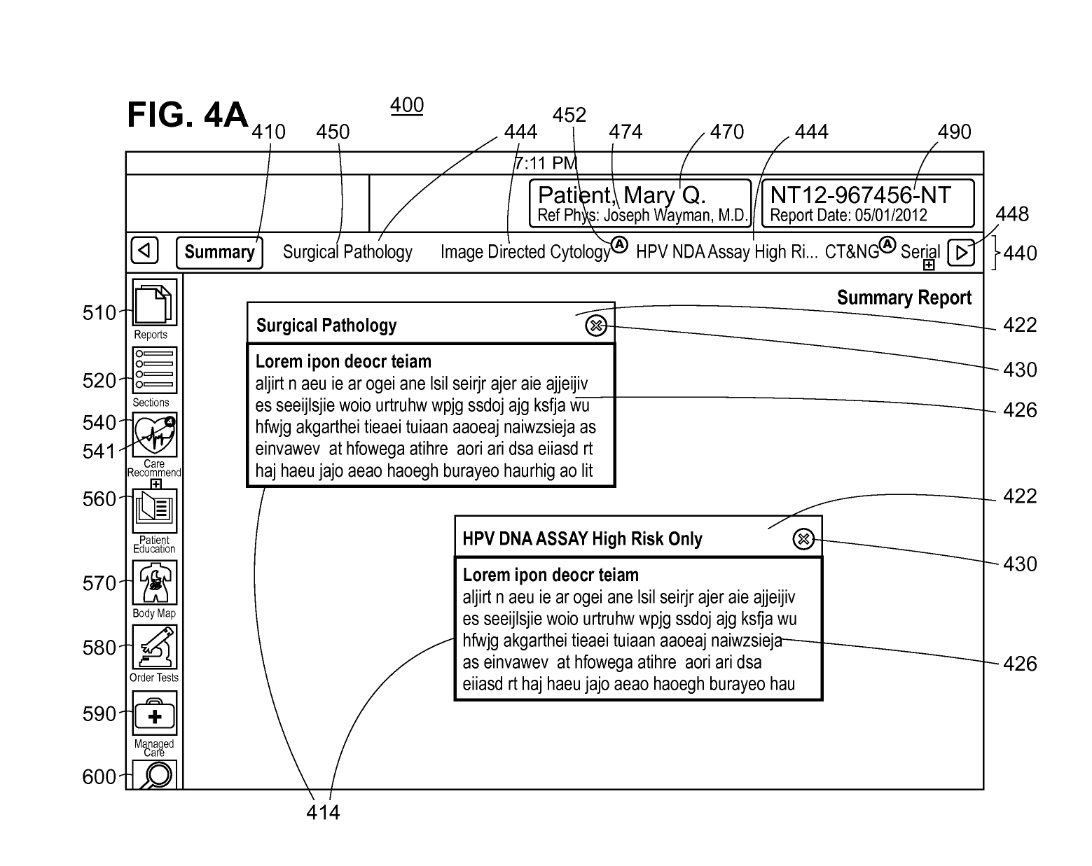

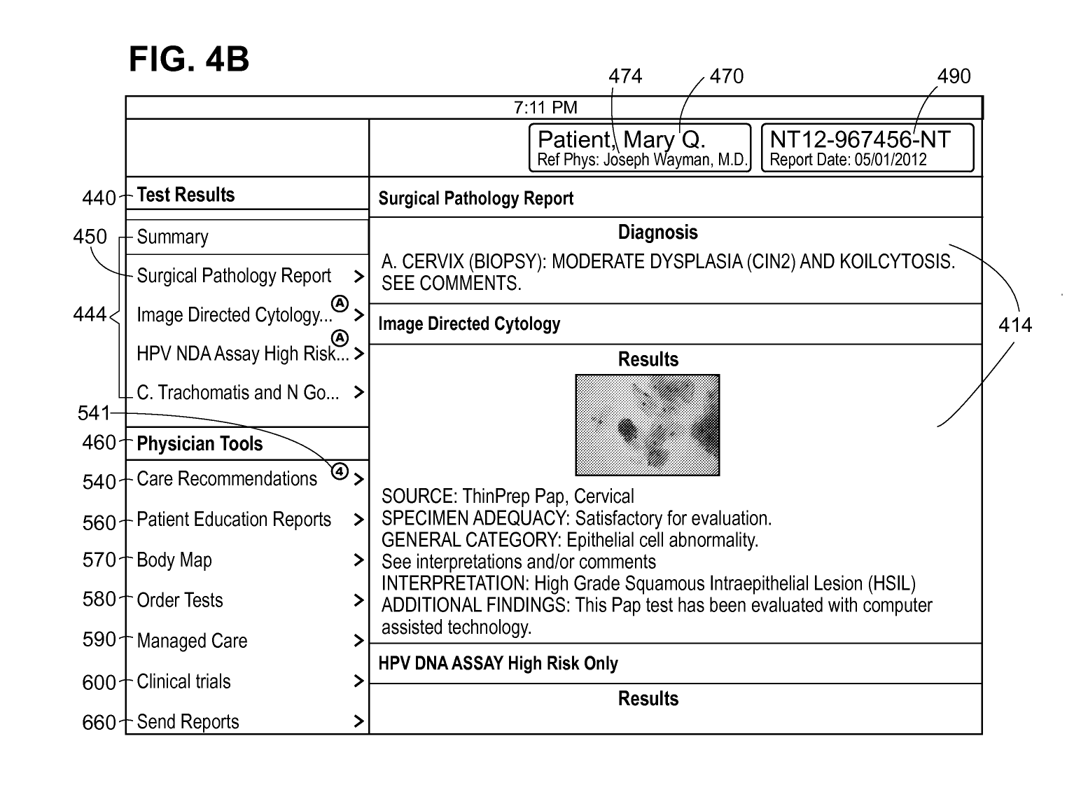

FIGS. 4A-4B depict a Main Reports Screen 400 such as a mobile device may present in connection with an embodiment of the invention. In an embodiment of the invention, this screen 400 may be regarded as the home screen of the dynamic report. The user may be brought to this screen by another application, such as a browser or special-purpose app, which may pass the patient information to the dynamic report. In an embodiment of the invention, the dynamic report may use this patient information to retrieve information specific to this patient, the report, or both.

It will be appreciated from the definition of “report” above that a report may include other objects that may also be considered reports. For example, in an embodiment of the invention, a report of the results of a panel of tests includes reports of the results of the individual tests that make up the panel.

The depicted Main Reports Screen 400 presents a Summary Report 410. Like other reports 510, discussed below, a Summary Report 410 may in an embodiment of the invention include multiple sections. For example, in an embodiment of the invention, each of the other reports in the set corresponds to its own section of the Summary Report 410. Each section may be presented in its own section window 414, and each section window 418 may be separately moveable, resizable, or both.

Each window 414 may include a title 422 of the summarized report and the corresponding summary 426. In an embodiment of the invention, not all section windows 418 need be displayed at once, and each section window 414 may include, e.g., an icon 430 that, when selected, dismisses the associated section window 414.

The depicted Main Reports Screen 400 includes a horizontally scrollable menu 440. The menu 440 includes the titles 444 of all other reports in the set. The menu may include controls 448 to cause scrolling, e.g., when the not all of the titles 444 will fit in the allotted space. The menu 440 may also indicate, e.g., by presenting a badge indicator 452 with a title, if the named report includes abnormal data that urgently needs attention.

A vertically scrolling bar 460, discussed further below, allows access to report sections and physician tools.

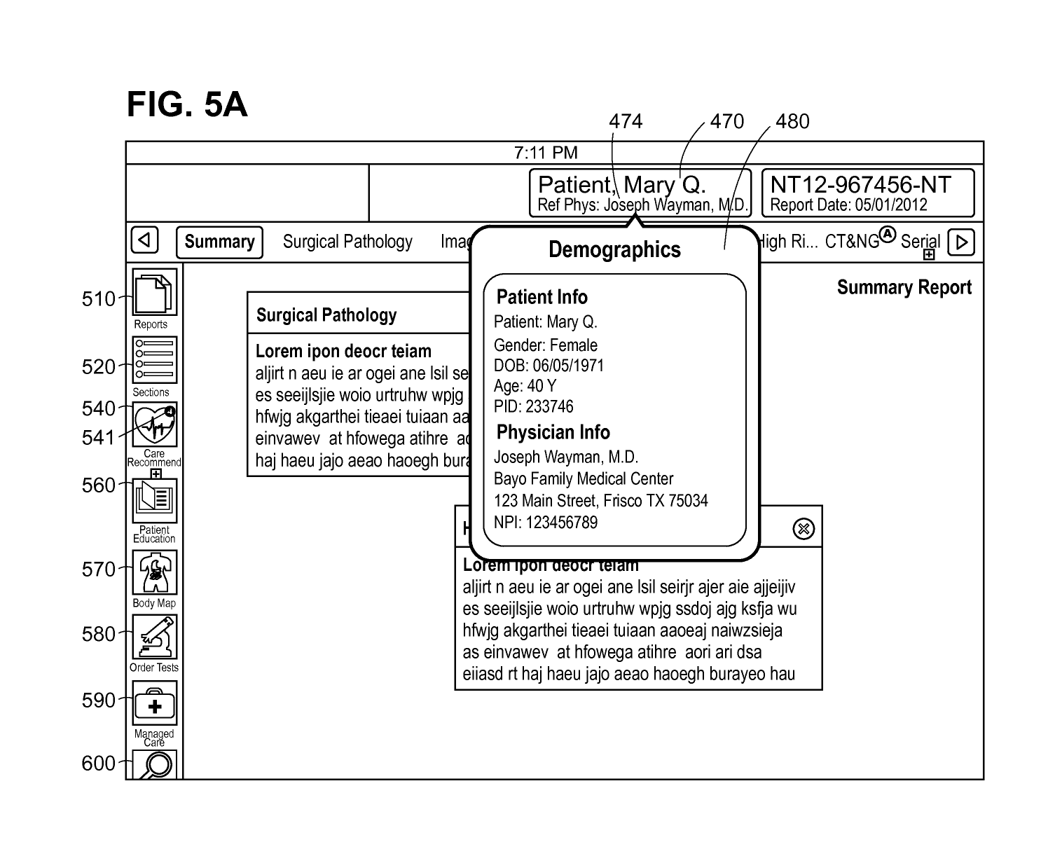

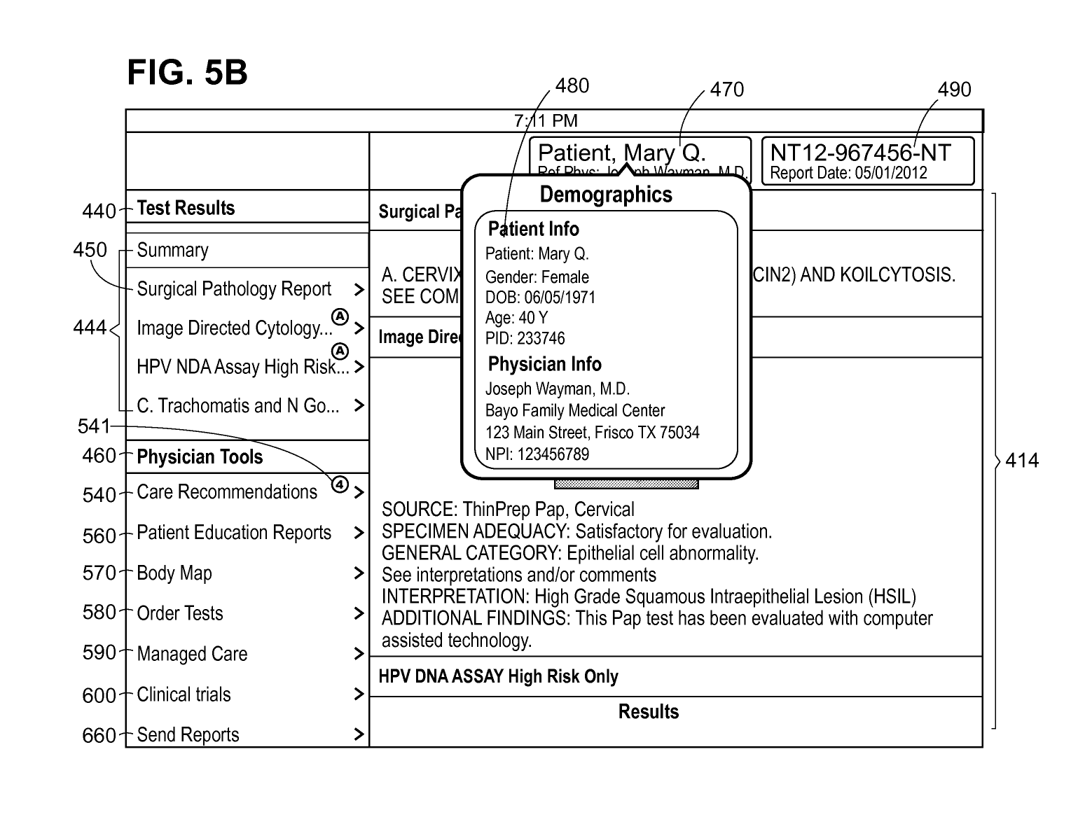

In an embodiment of the invention, the Main Reports Screen 400 will include a patient information button 470, which may display, e.g., the patient's name 474. Tapping the patient information button 470 will cause display of information about the patient. FIGS. 5A-B depict embodiments of the Main Reports Screen 400 with a callout 480 displaying the information. In embodiments of the invention, tapping again may close the callout 480.

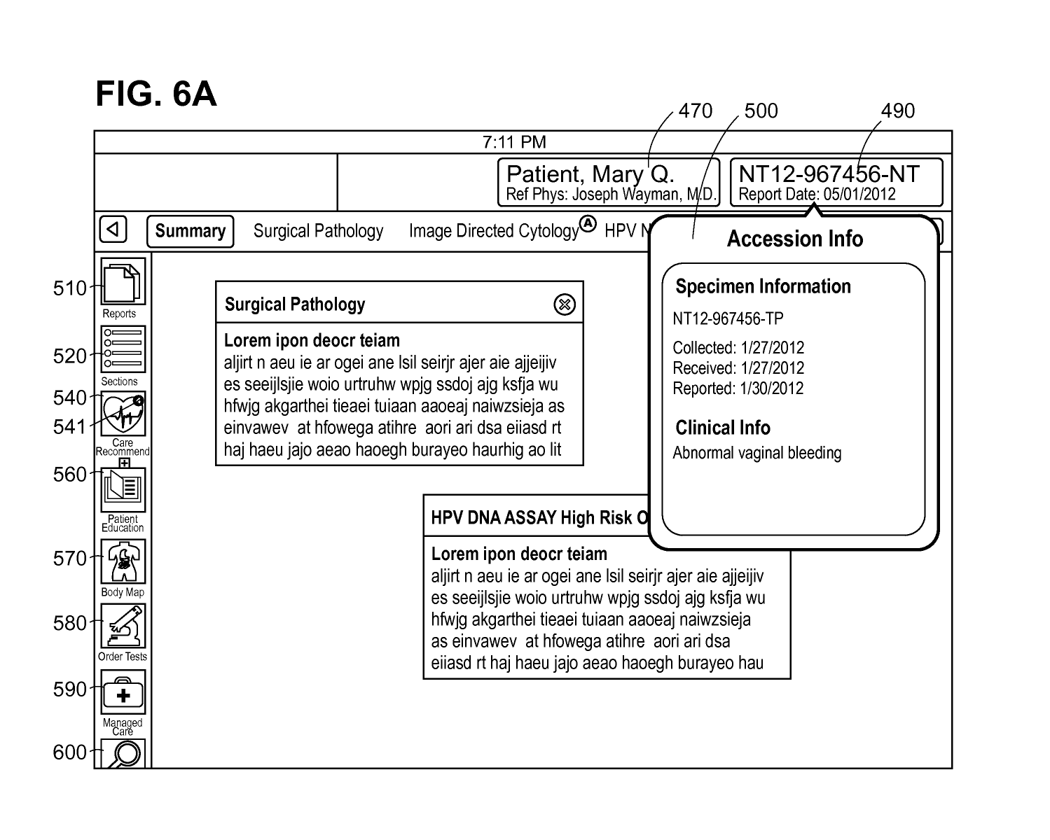

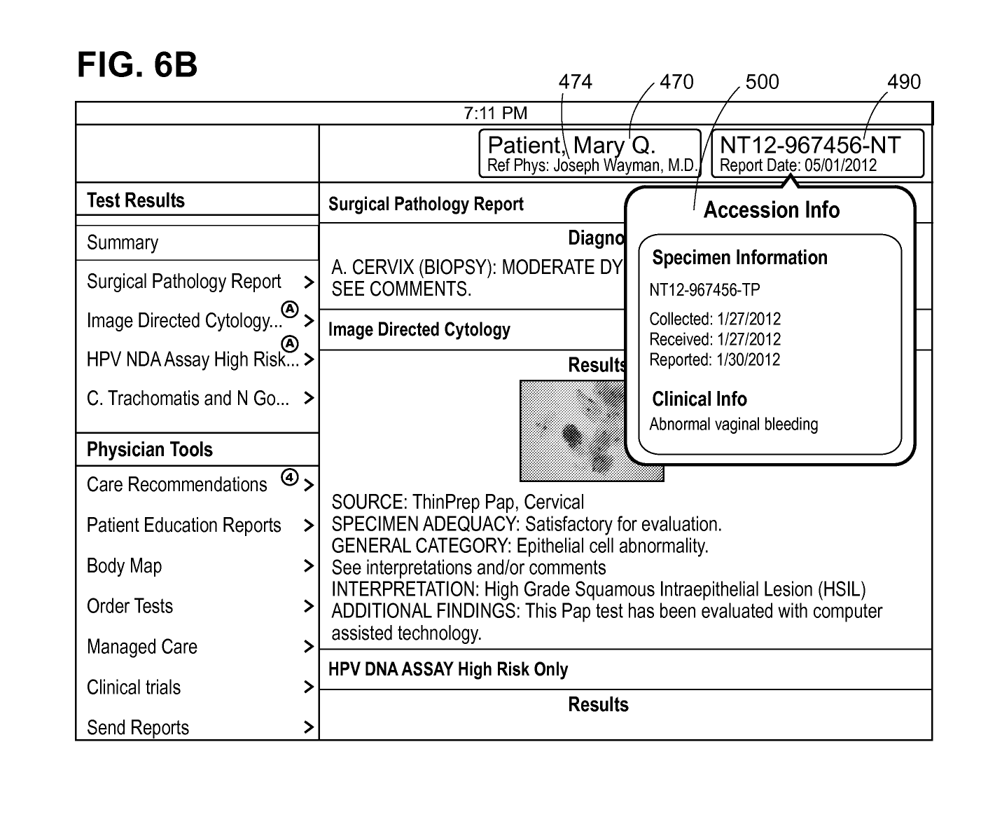

Similarly, in an embodiment of the invention, the Main Reports Screen 400 (FIG. 4) may include an accession information button 490. Tapping the accession information button 490 may cause display of a callout 500 such as FIGS. 6A-6B depict. This callout 500 may include information about the report set, including, e.g., information 504 about the specimen and its handling and/or clinical information 508 about the patient, such as one or more conditions or diagnoses associated with the test. Tapping the accession information button 490 again will close the window.

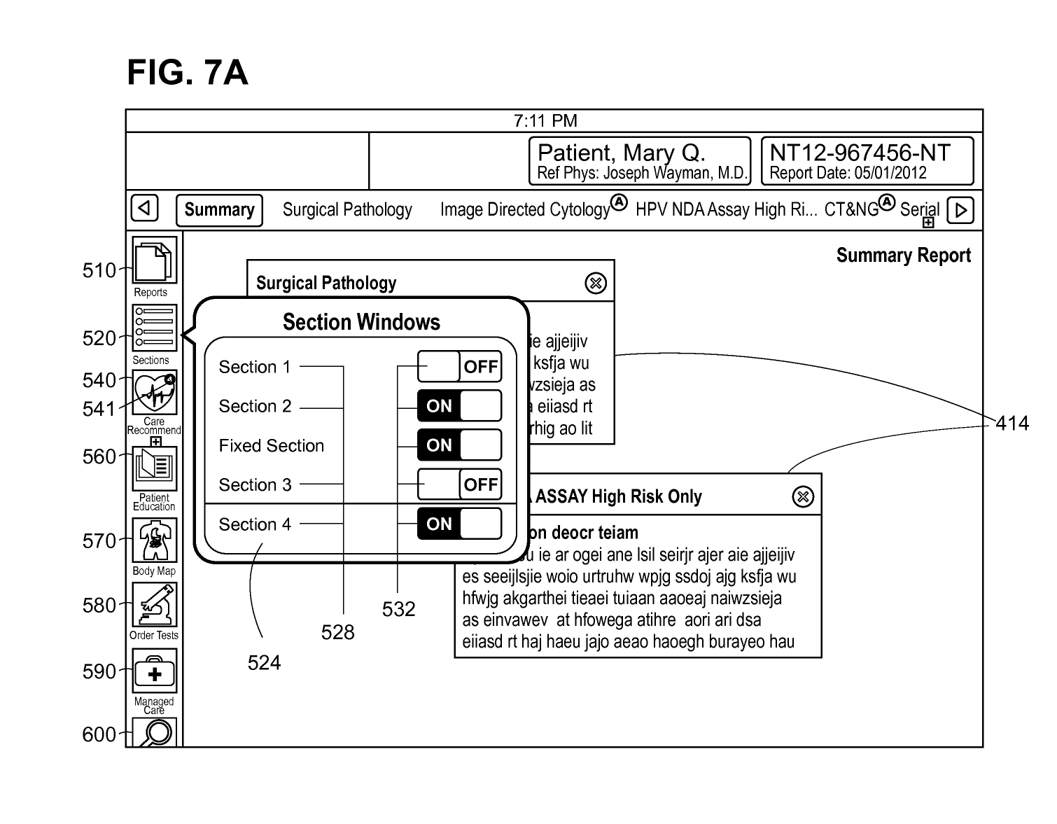

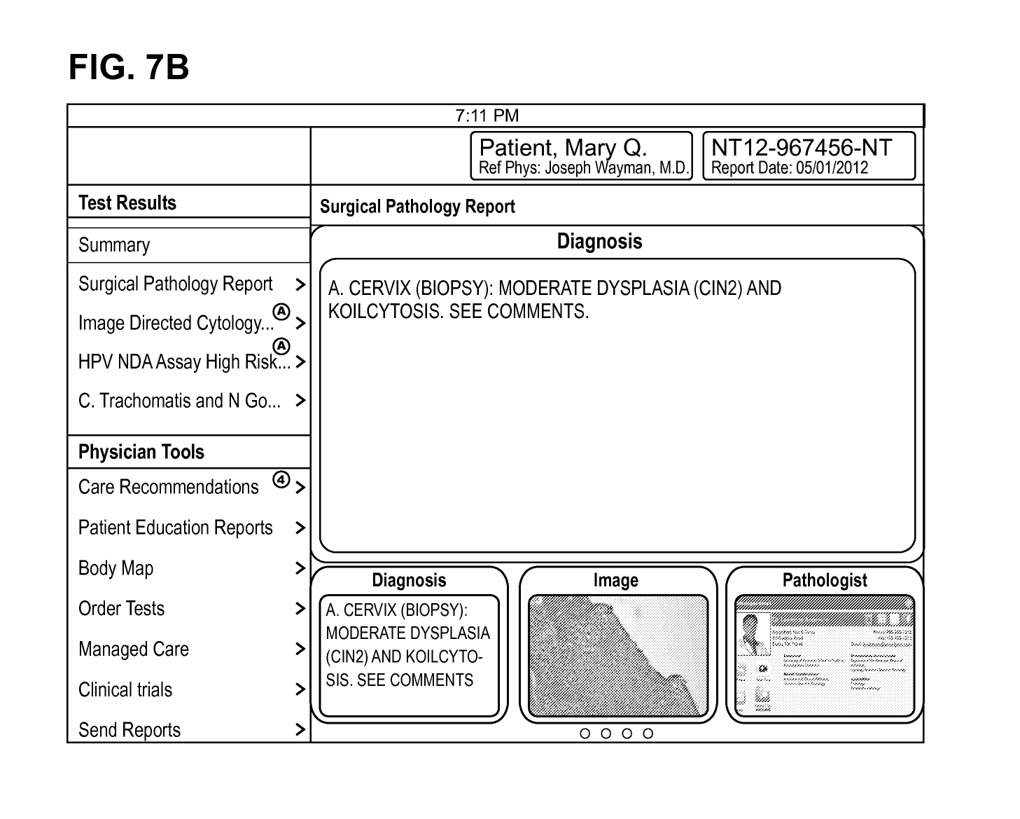

In an embodiment of the invention, each report may include several sections, which vary depending on the report. In an embodiments such as FIGS. 4A-4B depict, each section may be presented in its own separate window 414. To open or close windows, the user may tap the icon or item 520 labeled “Sections” on a left-hand tool bar 460. In response, as FIG. 7A depicts, a list 524 of the sections 528 of the report may be presented. Each listed section 528 may be associated with a respective control 532, which may allow the user to manage the section windows 414. Tapping the icon or item 520 again may dismiss the list 524.

The user may be able to personalize the appearance of any report. For example, in an embodiment of the invention, the user may open, close, move, and/or resize any report window 414 (FIG. 4A). For any report, the user's configuration may be stored, e.g., locally as provided for by HTML 5 or otherwise.

In an embodiment of the invention, each section (as displayed in its section window 414) may include text, images, and/or other media, and which may be represented, e.g., as HTML and other associated objects. The content of a section window 414 may be scrollable if the content is longer than the vertical size of the window.

The sections of a report may in an embodiment of the invention vary depending on the nature of the report. For example an anatomic pathology report might include sections for, e.g., a description of the specimen, results of the analysis, information about the pathologist who reviewed the specimen, and images, e.g., charts, photos, and/or photomicrographs.

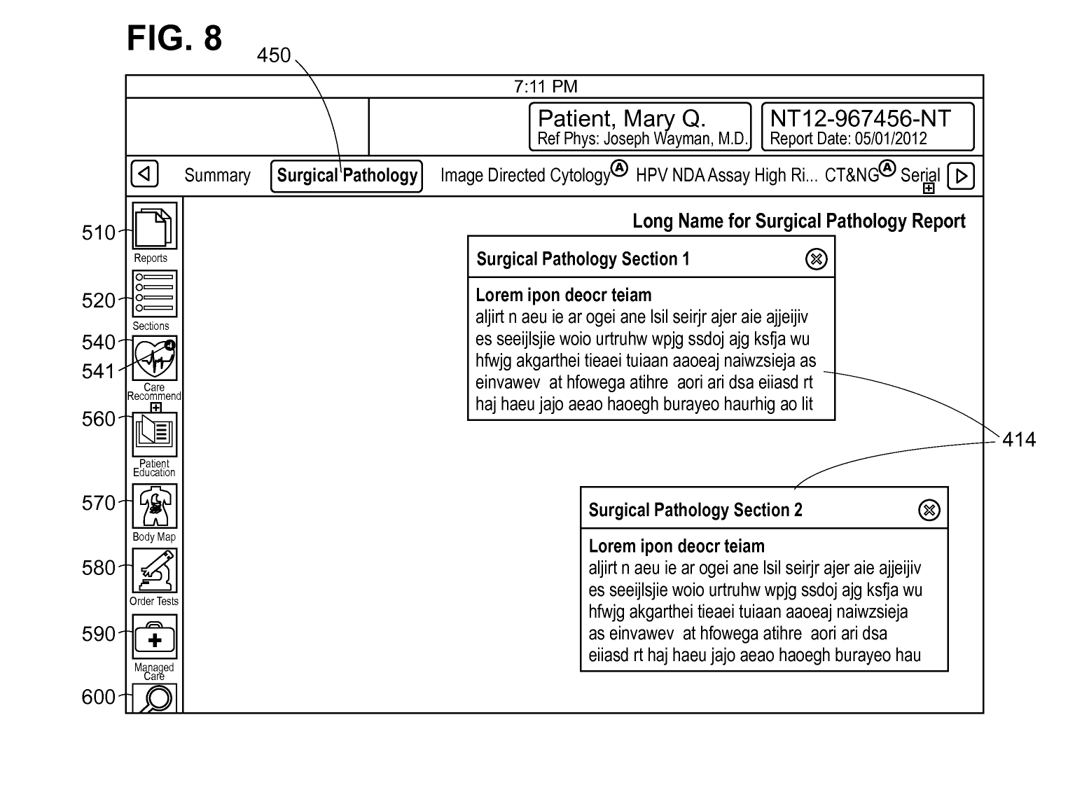

For example, FIGS. 4A-4B depicts a report set that includes a report of a surgical pathology test. To view the sections of that report, in an embodiment of the invention, the user may select the “Surgical Pathology” item 450 from the menu 440. As shown in FIG. 8, a plurality of sections for the “Surgical Pathology” item can be presented, each section in its own separate window 414. Each section window 414 may be separately moveable, resizable, or both. Each section can also include text or images, and further can be configured to be scrollable is the content is larger than the size of the window 414.

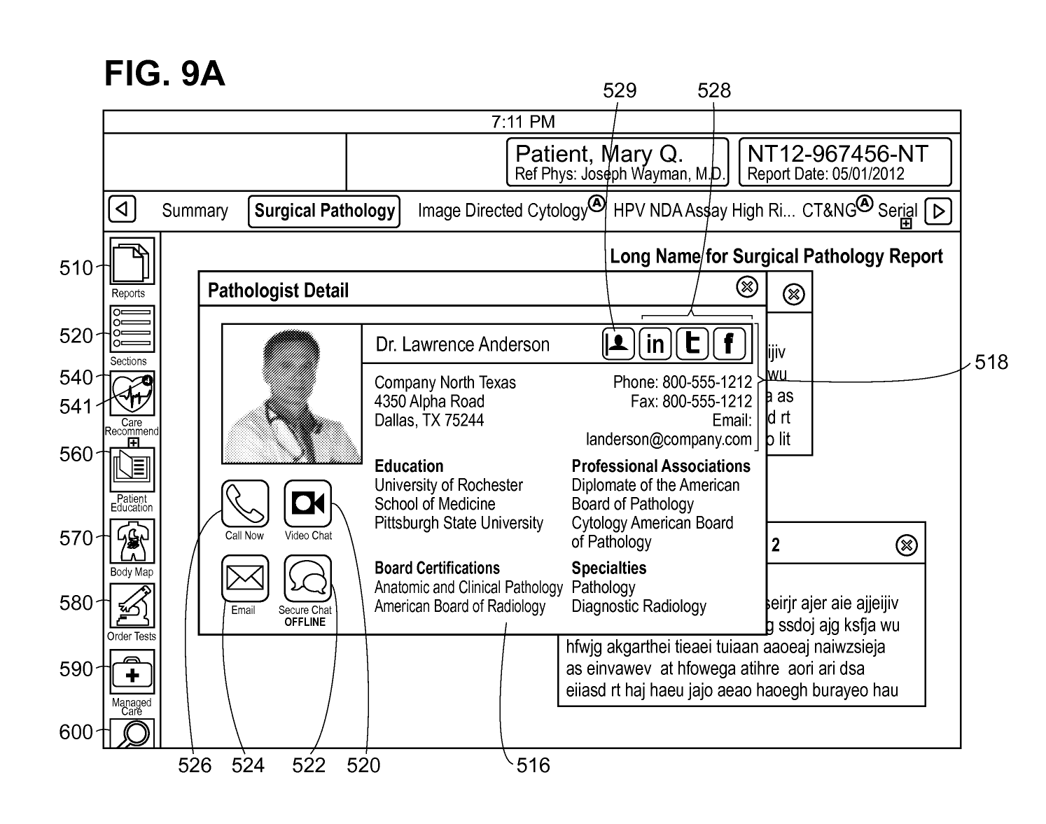

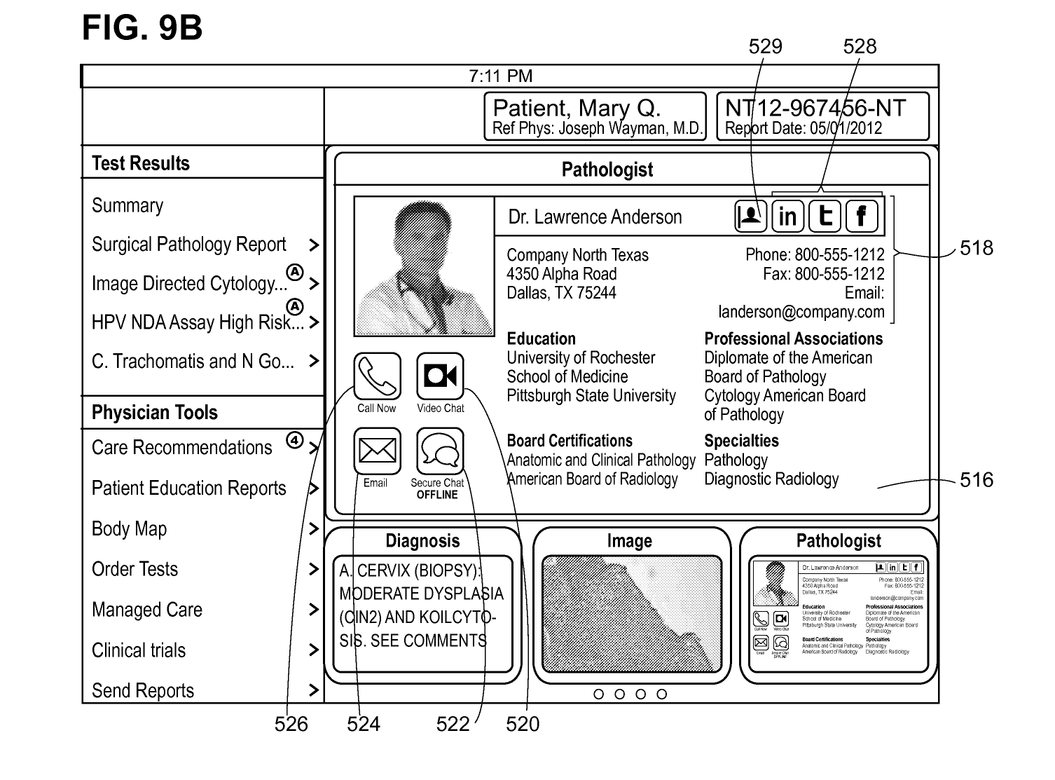

Each report may have a named pathologist as a signatory on certain aspects of the report. As shown in FIGS. 9A-9B, a Pathologist Detail item can be presented, for example in a Pathologist Detail window 516. This window 516 can include contact information 518. As shown in FIG. 9, the contact information 518 can include the pathologist name, contact information, email address (hyperlinked), email button, data on specialties, education, certifications, associations, etc. Thus if a user (e.g. a physician) needs to contact the reading pathologist for details on the report, the contact info is provided. Further mechanisms for communication with the pathologist can be configured such as video conferencing 520, instant messaging 522, email 524, and phone 526, as well as and other forms of collaboration. The window 518 can also be configured to include social media links 528 and a button 529 to add the pathologist to the user's electronic address book on the local tablet device. As with other windows described herein, the window 516 can be movable, re-sizeable, and otherwise configurable by the user.

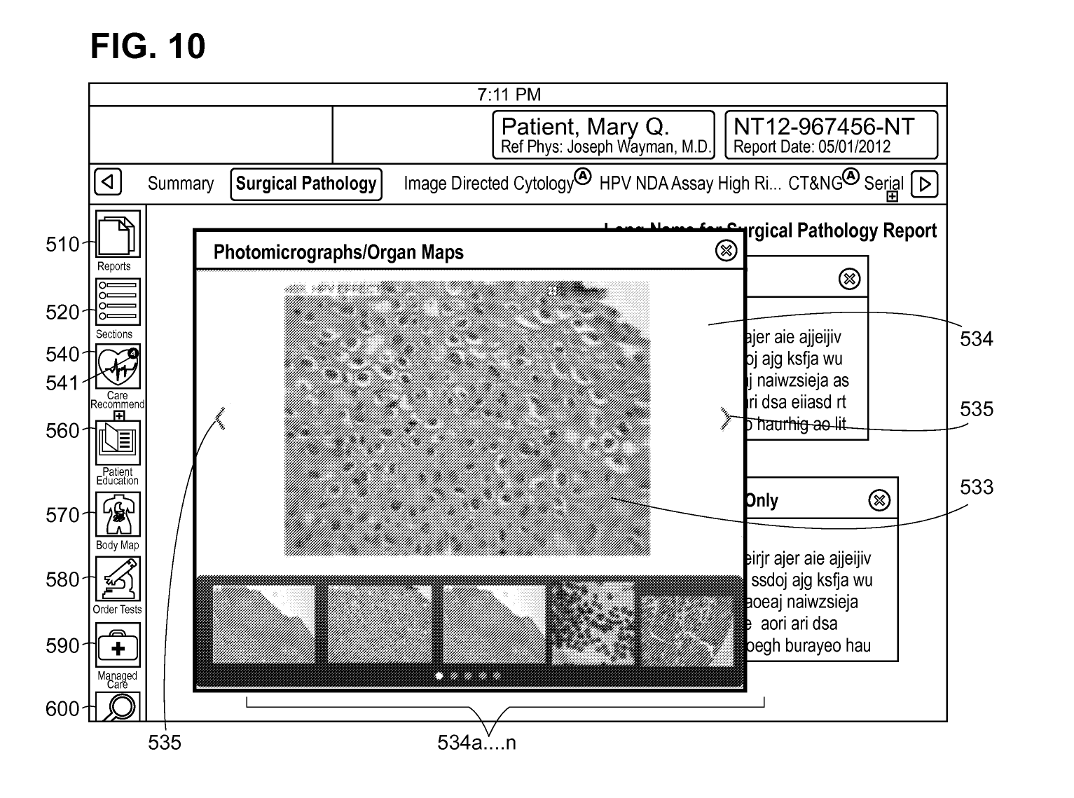

In an embodiment, in addition to the formatted text report sections, the report set can also include images. As depicted in FIG. 10, a report can include an image window 530 for a report. Where a report contains more than one image, in an image window can include a gallery of images that allows the user to navigate thru them quickly.

For example, as shown in FIG. 10, an image window 530 includes an Image Gallery of Photomicrographs/Organ Maps 530. A gallery 532a . . . n of thumbnail images sit on horizontally scrollable carousel control 531, and tapping any thumbnail 532a . . . n will load a main image 533 of the thumbnail into a pane 534 above the gallery 532, fit to the window. Controls 535 to the left and right of the main image 533 allow the user to move to the next or previous image in the carousel. Like all carousel controls as known in the art, when a user reaches the end and tries to proceed past a final image, they will be brought back to the beginning of the list in a loop.

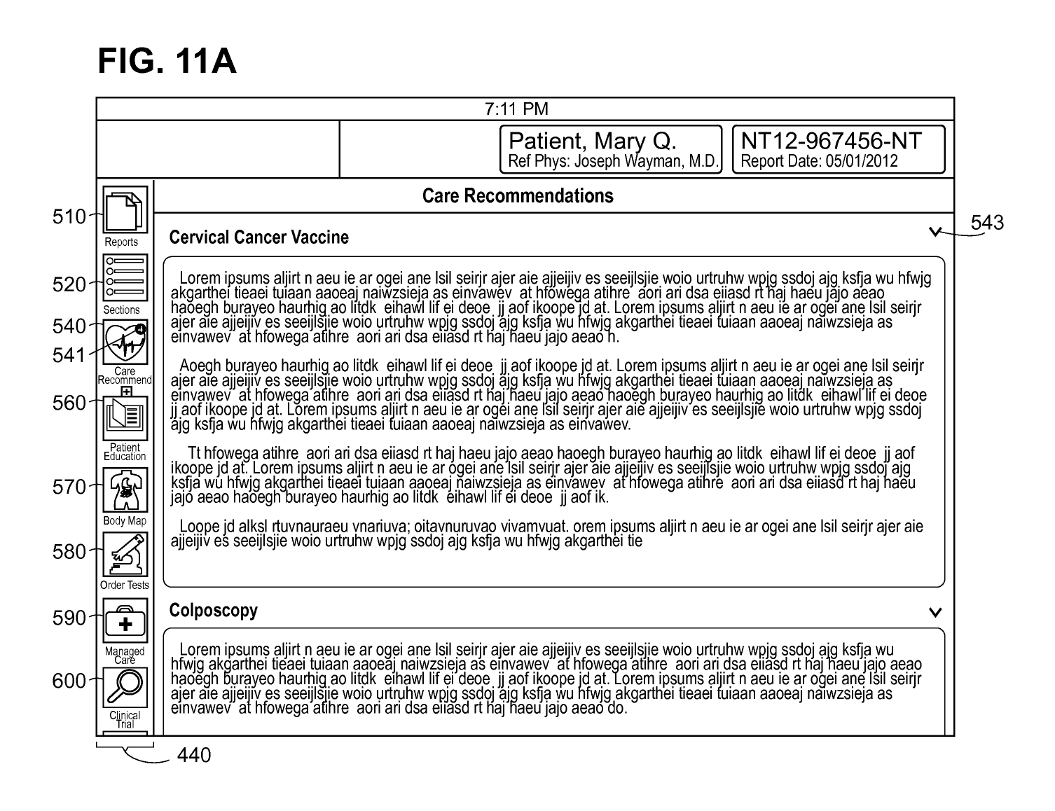

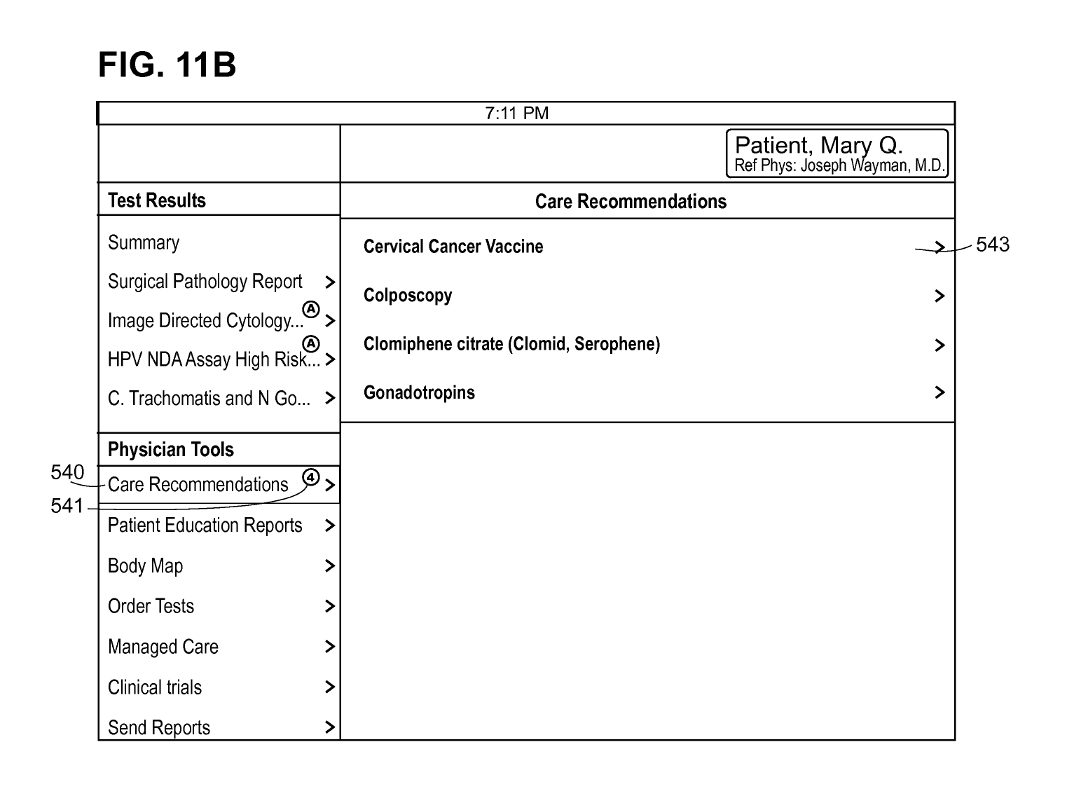

Based on test results in a report, there may be suggested courses of actions for the patient that are suggested to the physician. In an embodiment, a Care Recommendations section 540 lists the recommendations based on current test results of the report and a medical history of the patient. To view the sections of that report, in an embodiment of the invention, the user may select the “Care Recommendations” item 540 from the menu 440. A badge indicator 541 on the toolbar icon for the item 540 to indicates that there are care recommendations under menu item 540 that the physician or user should be aware of. A number within the badge 541 indicates the number of items the physician is being alerted to. Tapping the icon for the item 540 will display a page as shown in an exemplary embodiment shown in FIG. 11A. The recommendations can listed in an accordion style tab page, with each heading representing one recommendation article. All headings are expanded by default, but can be collapsed (as shown in the embodiment of FIG. 11B) expanded by tapping a header 543. The entire content area can be configured to be scrollable.

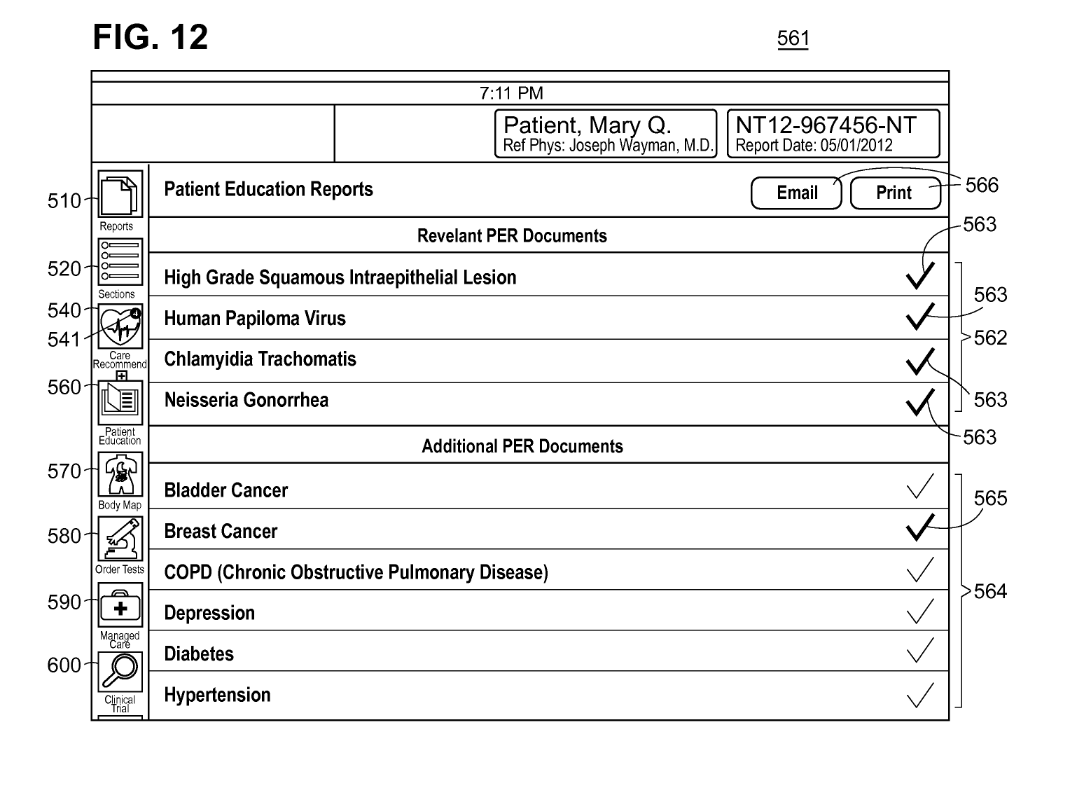

In an embodiment the report can also include Patient Education Reports (PER) 560. Patient Education Reports allow a user or physician to print or email relevant articles or reports for a patient with regards to their current conditions or diagnoses. To view the sections of that report, in an embodiment of the invention, the user may select the Patient Education Reports item 560 from the left-hand icon for the item 560 toolbar. When selected, the user is presented a screen 561 as depicted in FIG. 12. The top section of the window shows a Relevant PER Document section 562, which is auto-selected by default based on the medical history of the patient. A physician can unselect a PER if he or she chooses not to deliver a pre-selected PER to the patient. Items can be unselected, for example by tapping a line item control 563 for the report. A bottom section lists “Additional PER Document” section 564 that the physician can choose from. Tapping any item will select the PER document, and the selection can be confirmed, for example by a check mark icon in the far right column. The two control icons 566, 567 control the printing and emailing of the article content.

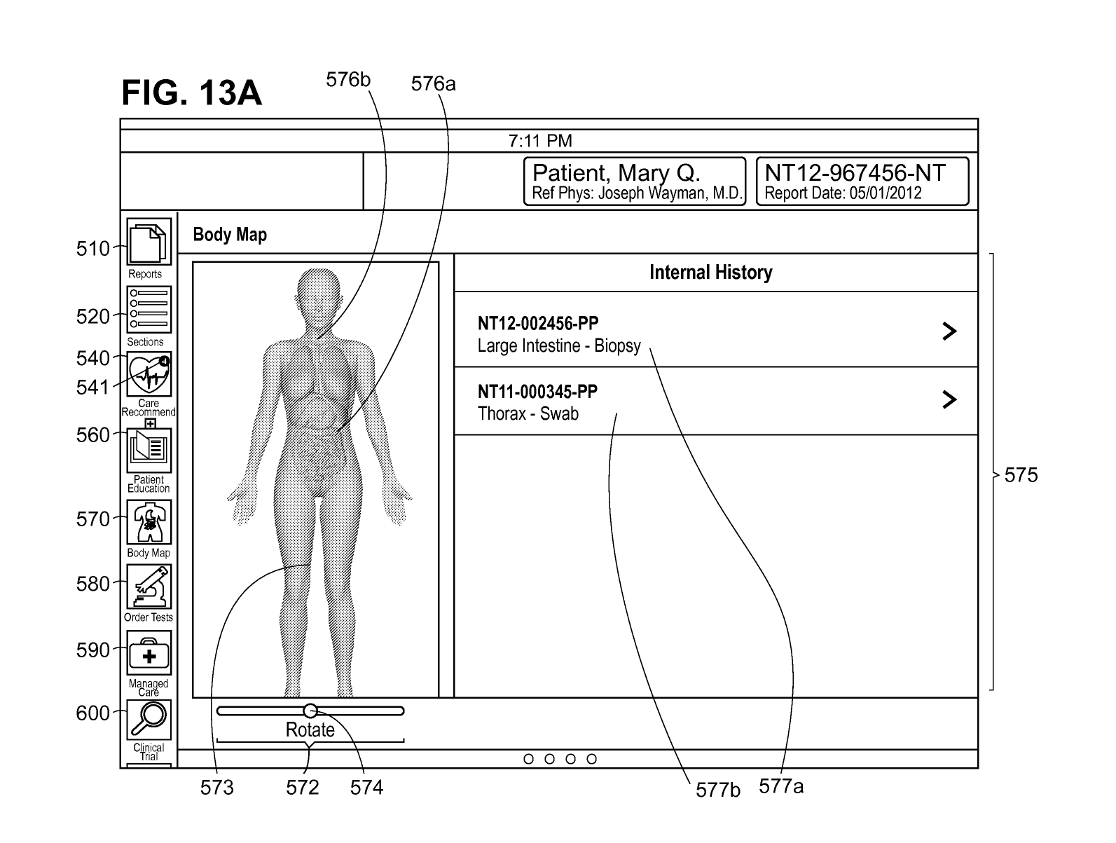

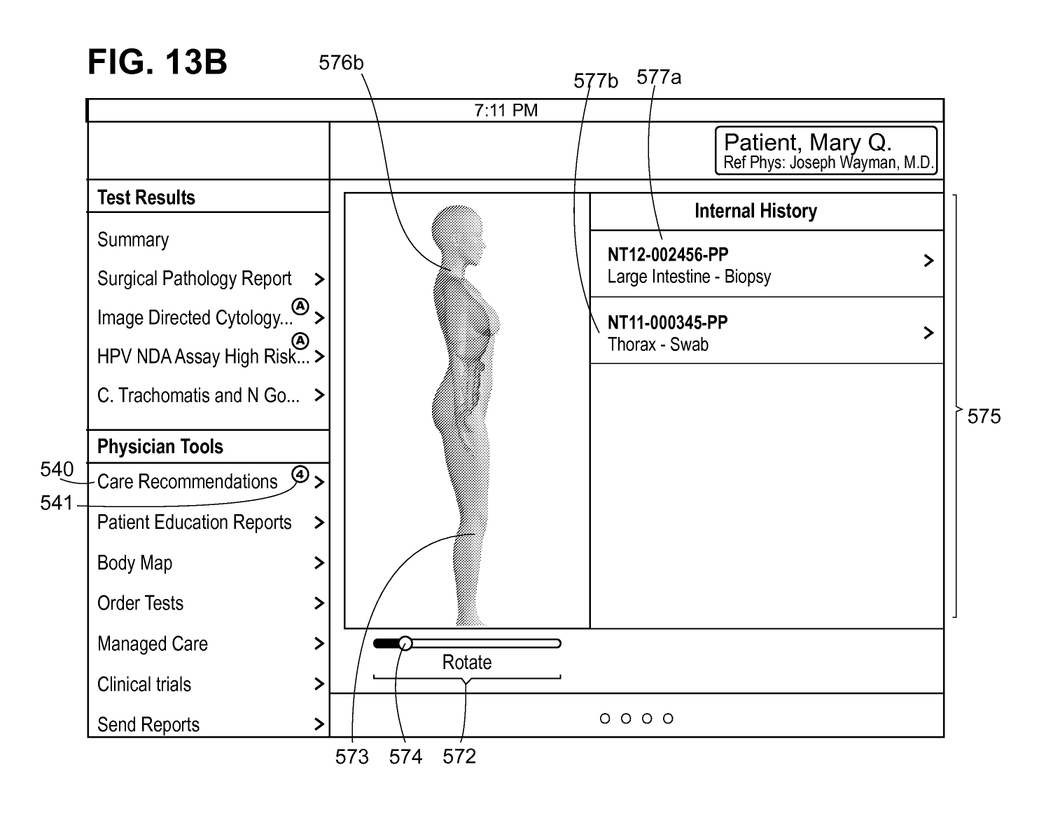

In an embodiment the report can also include a Body Map 570 tool. The Body Map 570 tool provides physicians with a history of reports for a patient filtered by physical body subsystem, for example circulatory, nervous systems, skeletal system, etc. An exemplary embodiment a Body Map 570 interface is shown in FIG. 13. As depicted in FIG. 13 a Body Map screen 571 is broken into two sections, a body view section 572 including a rotatable image of a body 573 and history section 575 for listing one or more reports. The rotating body 573 view is controlled by a slider control 574 shown as positioned under the body image 572 in the first section 572 for the body.

In one embodiment, sliding the rotation control 574 moves the view through a series of images to simulate a rotating image of a generic body (male or female) showing the “layer” of the body image 573 with a particular subsystem 576a, 576b of interest showing on the body image 573. In an embodiment, the body views can sit on a carousel control allowing a user to swipe through available body map views.

For example, as shown in FIGS. 13A-13B, a Large Intestine graphic 576a and a Thorax graphic 576b is shown on the body image 573. A specific test site report 577a, 577b on the report history in the history section 575 can be noted on the body view section 572. The history section 575 includes a list of reports 577a, 577b for that patient related to body view 573, with each report 577a, 577b corresponding to a subsystem 576a, 577b illustrated on the body image 573. For example, as shown in FIGS. 13a-13B, a Large Intestine Biopsy report 576a and a Thorax Swab report 576b are listed in the history report section 575, each of which respectively correspond the Large Intestine graphic 576a and a Thorax graphic 576b on the body image 573. Tapping a report name will bring the user back to the report screen (see FIG. 4) with the windows 414 for that report visible.

In an embodiment, physicians have the ability to order additional tests based on the results of the ones currently reviewed. The user can access this page by tapping the Order Tests icon 580. Order entry screen(s) (not shown) can be configured to allow a physician to select from a set of tests to order for a patient. This information, along with patient information, can then be passed to a connected order processing system for processing the order

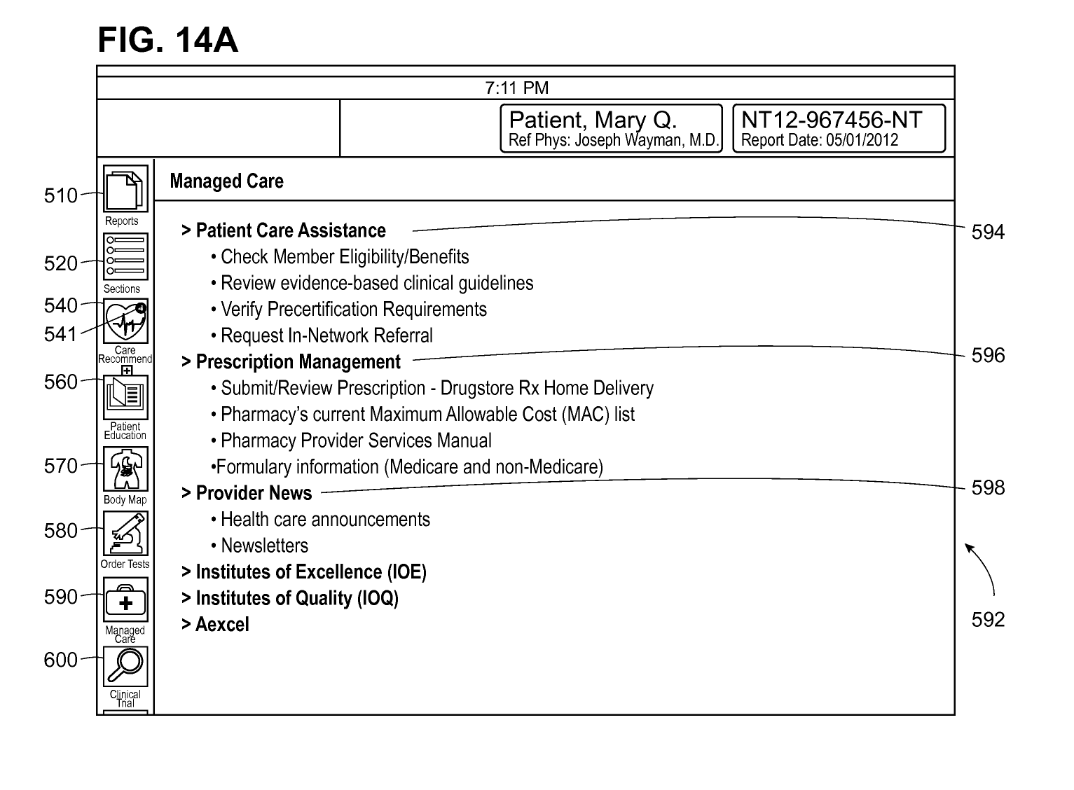

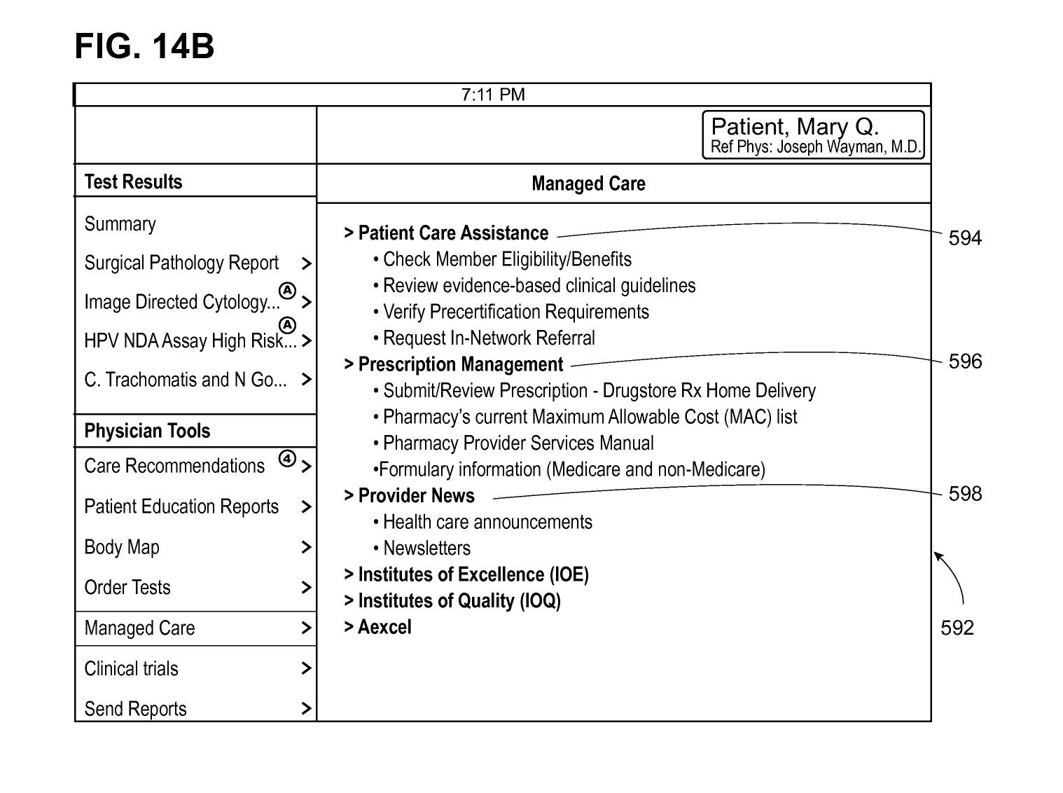

In an embodiment a Managed Care 590 tool is provided. The Managed Care tool 590 is configured to allow physicians to access patient support information and support systems provided by third party managed care providers so they have a complete set of tools at their disposal in supporting their patients. As shown in FIGS. 14A-14B, Care screen offers integration links or connections under a Patient Care Assistance section 594, Prescription Management section 596, A Provider News section 598, and so on. For example, Patient Care Assistance module can be configured with links to allow a physician to check a patient's eligibility for benefits, review evidence-based clinical guidelines, verify precertification requirements, or request an in-network referral. A Prescription Management module can include a link or interface with a system or service to submit or renew a prescription, obtain insurer guidelines or policies (e.g. Maximum Allowable Cost), a link or interface to a Pharmacy Provider Services Manual, and formulary information.

In an embodiment, a Clinical Trial Search tool 600 is provided. The Clinical Trial Search tool 600 can provide physicians with a means to match a patient with possible clinical trials that meet their medical needs. The tool 600 is driven from a external government website </http://clinicaltrials.gov/>, which provides a search API to work with. The API is XML-based and as such is configured to work with an application server to act as a data broker to preprocess the data as known in the art for use with the reporting application.

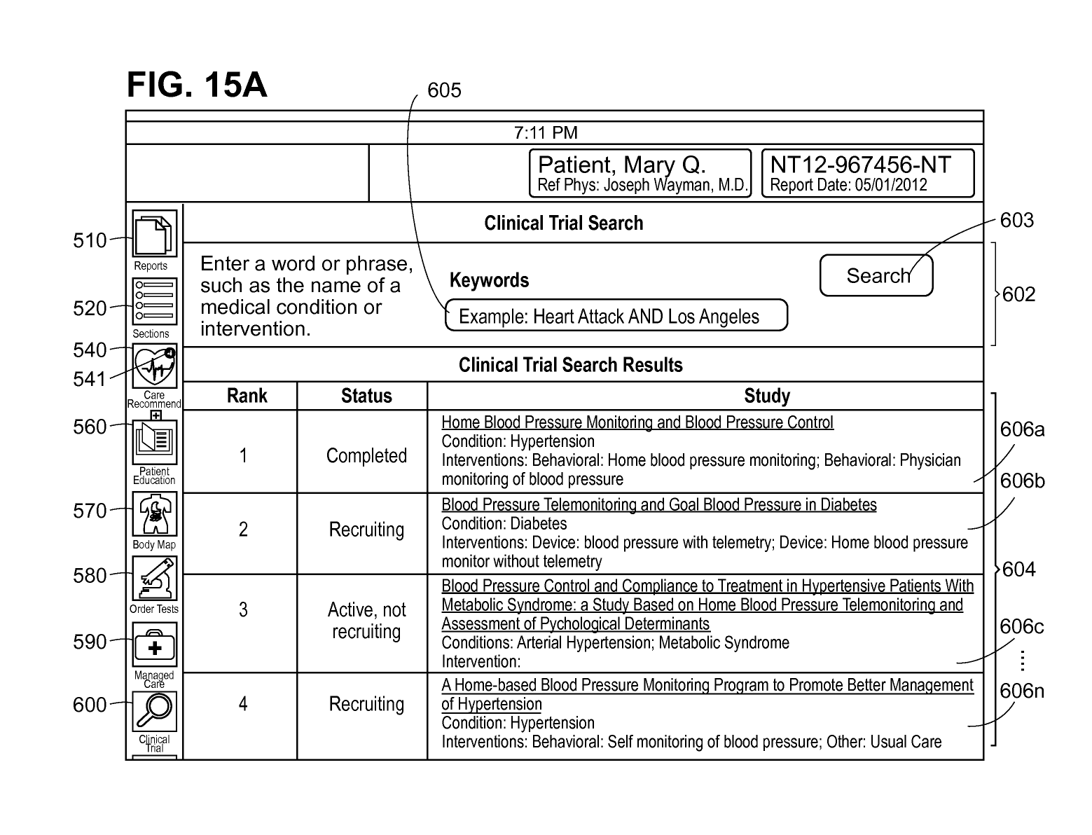

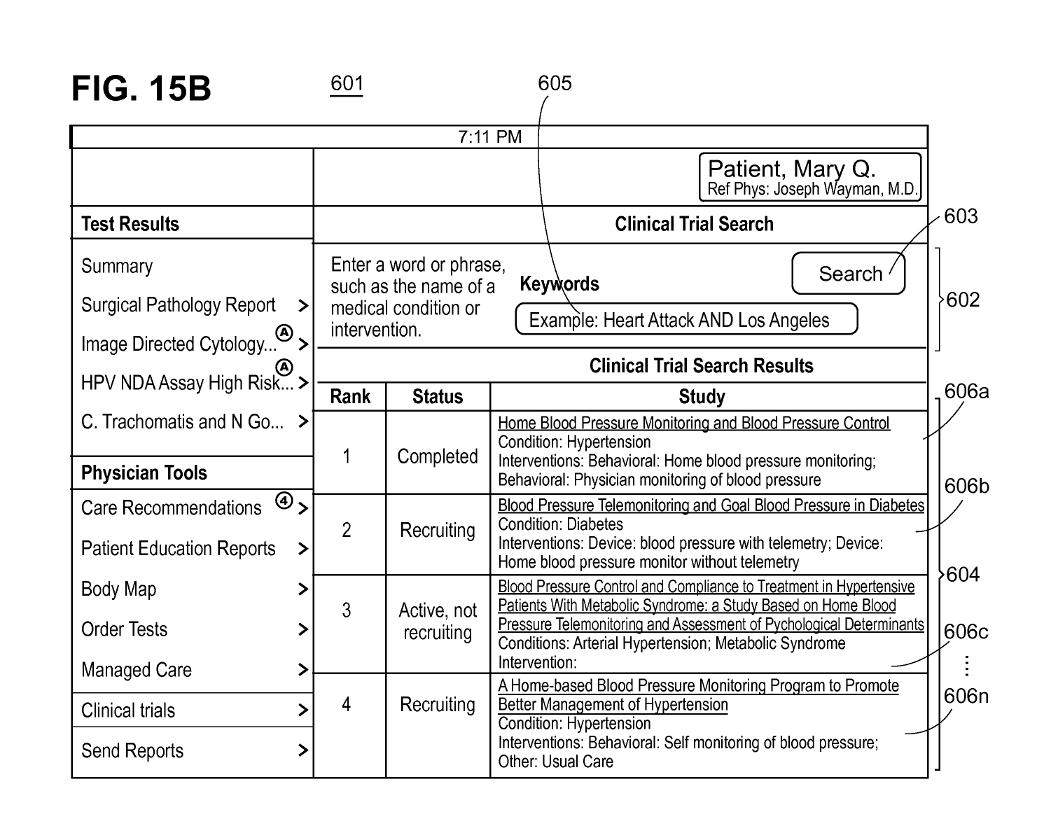

The Clinical Trial Search tool 600 opens to an API screen 601 configured with a search form 602 and the search results 604. As depicted in FIG. 15 the search form 602 is shown in the top-right panel, and provides the user with an input field 605 to search using keywords to locate a matching clinical trial. Once the user taps a “Search” button 603 the search form window will be replaced with a results window 604 as shown in a bottom-right panel of the screen. Each results item will have a hyperlink 606 a . . . n to clinical trial details. If the user wishes to go back and perform a new search, they can enter new keywords in the search field 605 and tap the “Search” 603 button on the top search panel.

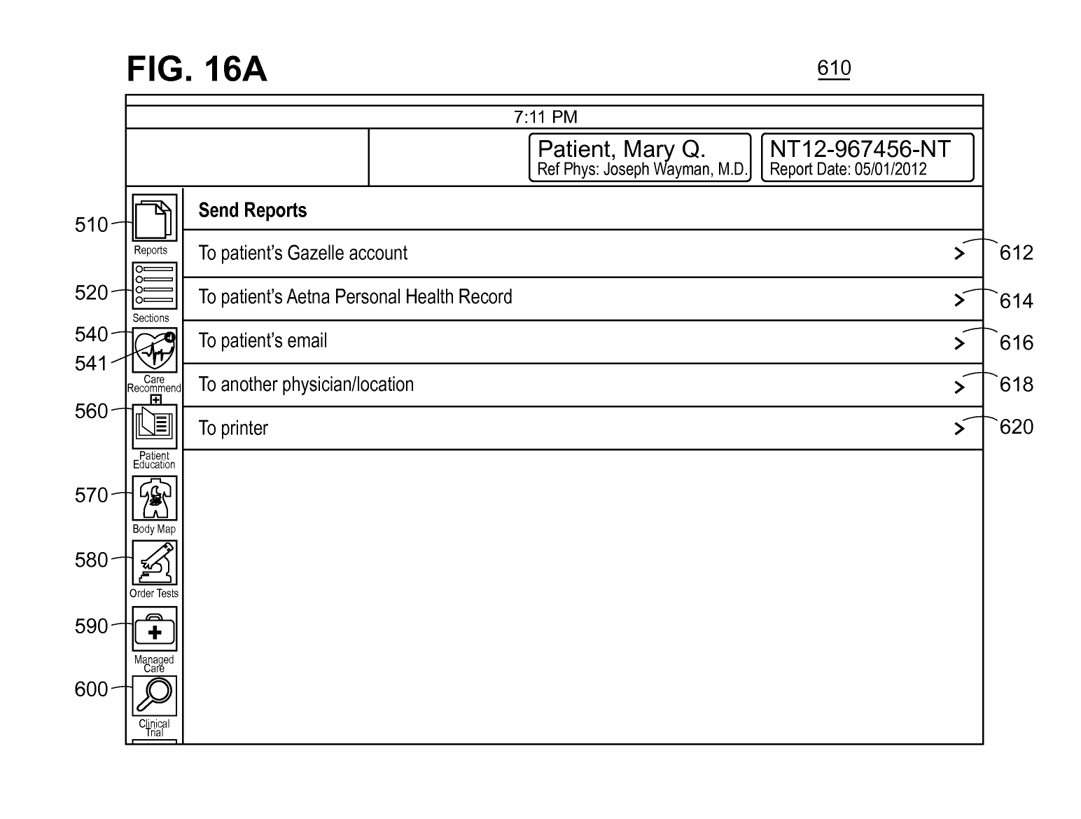

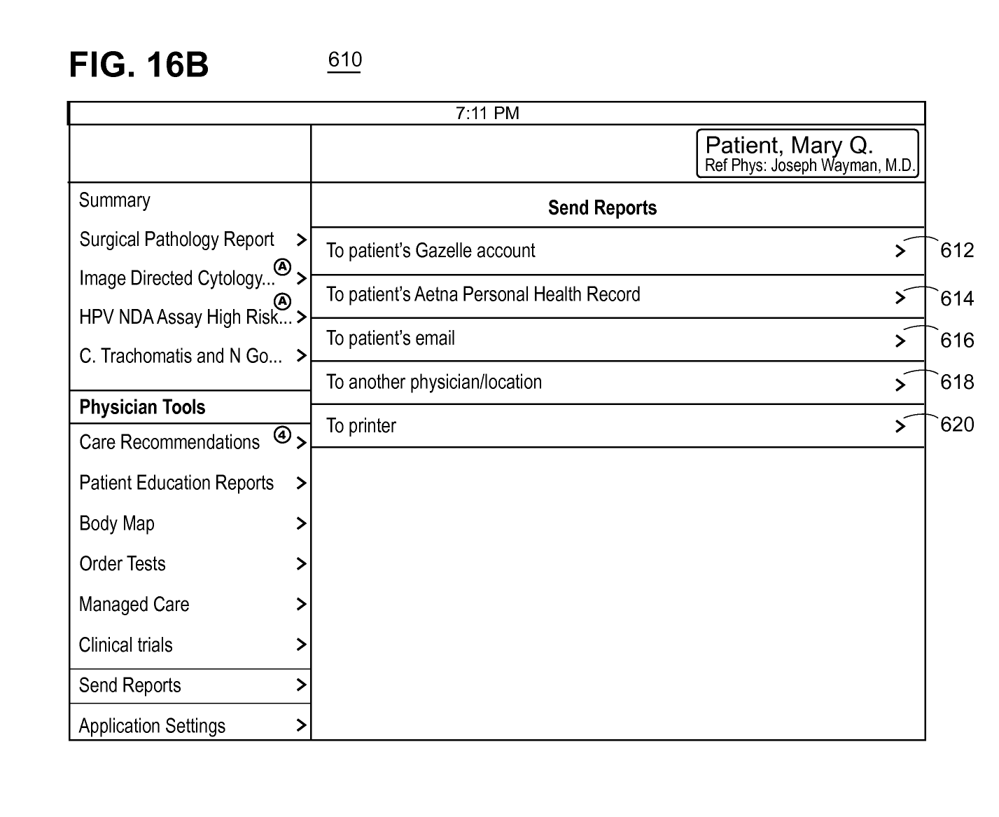

In an embodiment, a Send Report tool 660 allows a physician to send patient reports to a specific destination. For example, in an embodiment all the reports in report set can be sent to the specified destination, or the system can be configured to allow a user to send select reports from a report set. FIGS. 16A-16B show a screen 610 the user will see when selecting a “Send Reports” icon from the left-hand toolbar 460. As shown in FIG. 16, options can be provided to send reports to a patient' electronic health information record 612 (Gazelle account), an insurance provider's record 614 (Aetna Personal Health Record), the patient's email 616, to another physician 618, or to a printer 620. Once a link is selected, the system can be configured to generate the reports in a delivery format, for example as PDFs, and send or upload them to the linked location.

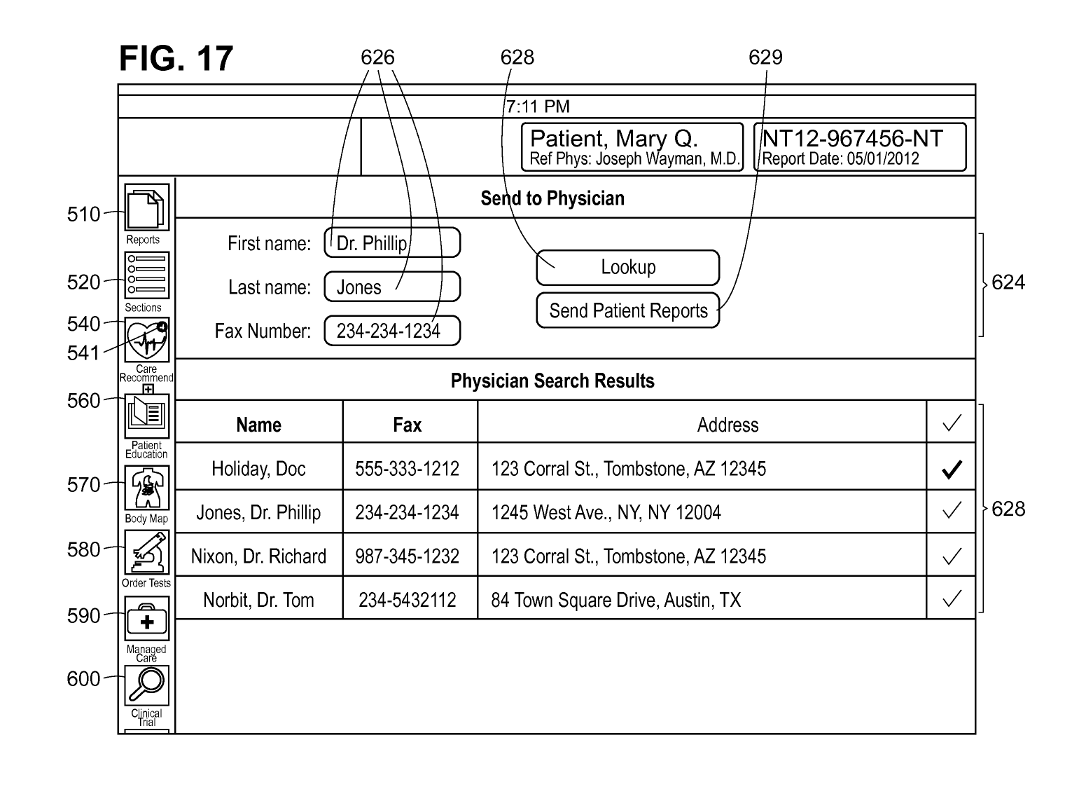

For example, upon selecting the another physician option 618, a Physician/Location screen 622 is provided which is configured to allow a physician to send reports to another specialist physician for a consult. Tapping this option 618 will display a screen as shown in FIG. 17. This allows a user physician to enter the name/fax of a physician/office he or she knows, or perform a search for a physician via a connected system including a database of other physicians using a search form 624 at the top of the screen 622. To perform a search, the user can enter a partial name and/or fax in search boxes 626, and tap a “lookup” or search button 628. The search results 626 are displayed in a search results panel 628 below the search form as shown in FIG. 17. Tapping a user in the search results will populate the search form with that user data. To send the reports to that destination, the user can select “send patient reports” button 629. After doing so, the screen closes and they are returned to the Send Reports 660 screen as shown in FIGS. 16A-B.

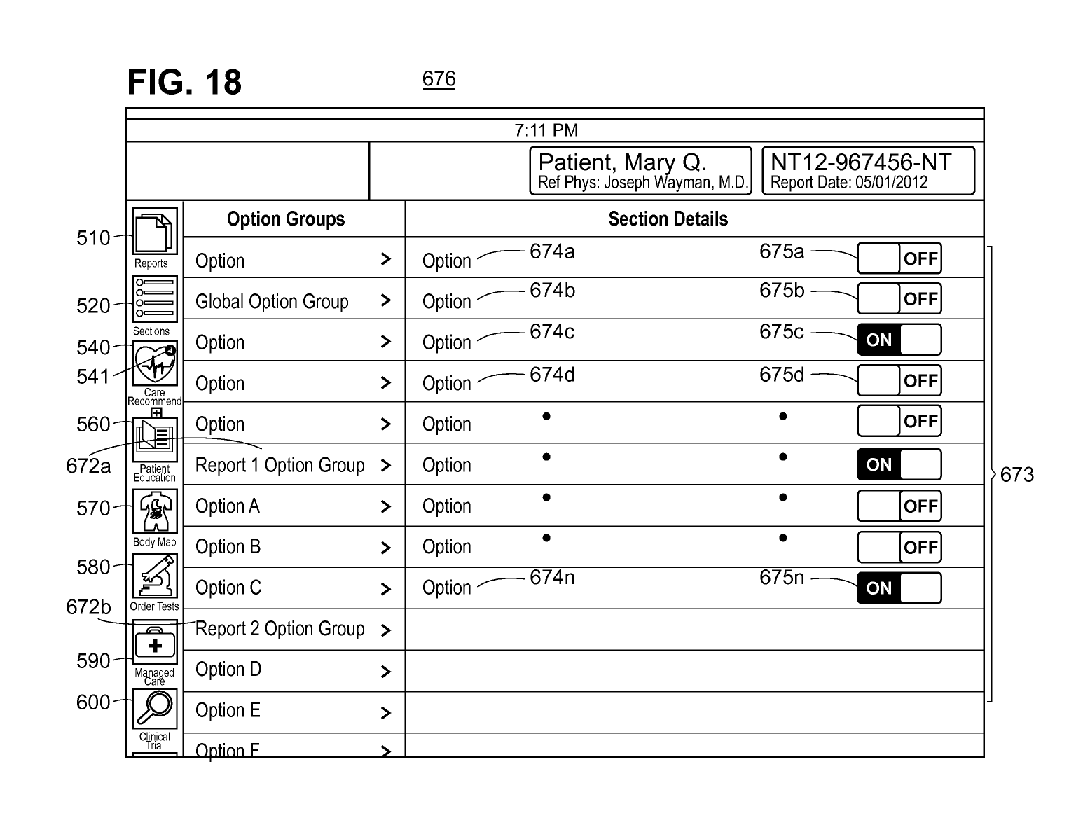

In an embodiment, the system is provided with Global and Report level settings 670 tool. These conditional settings allow for the display or hiding of windows, report sections, and other controls based on the user. An example of a settings screen 676 is shown in FIG. 18. Each report is provided with an Option Group 672a, 672b as shown in a left content section 671 column of FIG. 18. One of the options under the group will be Sections, provided in a Sections area 673. Within this Sections area 673, and option set include switches 675a . . . n allowing the user to turn on/off specific sections 674a . . . n by default, i.e. what windows to display by default when displaying that report.

In another embodiment, a more conservative user interface can be configured for a standard tablet based interface for a user. As depicted in FIGS. 4B, 5B, 6B, 7B, 8B, 9B, 11B, 13B, 14B, 15B, 16B, the functionality and configuration is substantially the same as that disclosed above, but the design replaces icons and windows standard text menus and sectioned text areas for content.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modifications are intended to be included within the scope of the invention. Except to the extent necessary or inherent in the processes themselves, no particular order to steps or stages of methods or processes described in this disclosure, including the Figures, is implied. In many cases the order of process steps may be varied without changing the purpose, effect or import of the methods described.

1. A computerized information management application for providing reports for a specific patient or a group of patients on a mobile device, the application comprising:
at least one interface for receiving data associated with a laboratory report for medical tests performed on a patient;
at least one interface information identifying one or more pathologists, technicians, or other persons involved in performing the test and one or more interactive tools for communicating with them.

2. The application of claim 1 wherein the interactive tools include a communication tool from a text messaging application, a phone, a video messaging application, and a real-time chat application.

3. The system of claim 1 wherein the mobile device comprises one or more user interface elements for acquiring further information about one or more of: a reported test, a test result, a medical condition that may be associated with a test and/or result, a drug or other medical treatment that may be associated with a test and/or result; historical medical information related to the report; and historical medical information related to the patient.
